(19) United States
(12) Patent Application Publication
(10) Pub. No.: US 2026/0221615 A1
(43) Pub. Date: Jul. 30, 2026

(54) SECONDARY CELL

(71) Applicant: Northvolt AB, Stockholm (SE)

(72) Inventor: Michael SHAUGHNESSY, Västerås (SE)

(21) Appl. No.: 19/141,742

(22) PCT Filed: Dec. 20, 2023
(86) PCT No.: PCT/EP2023/087098

§ 371 Date: Jun. 20, 2025

(30) Foreign Application Priority Data
Dec. 23, 2022 (SE) 2251579-5

(51) Int. Cl. H01M 50/536; H01M 10/04; H01M 50/107; H01M 50/152

(52) U.S. Cl. CPC H01M 50/536; H01M 10/0431; H01M 50/107; H01M 50/152

(57) ABSTRACT

There is disclosed herein a cylindrical secondary cell (1), comprising a cylindrical enclosure (2) comprising a first enclosure end (2a), a second enclosure end (2b) and an enclosure sidewall (2c) extending between the enclosure ends (2a, 2b), wherein at least one enclosure end (2b) is open. The 5 cell further comprises an electrode roll (20), a lid (10), and a current collector disc arranged between the lid and the electrode roll (20) and in direct electrical contact with the electrode roll (2). The cylindrical enclosure (2) comprises a flat flange section (2f) extending from the enclosure sidewall (2c) at the open enclosure end (2b), and the radially outermost portion of the lid 10 (10 ) is configured to abut and match the flat flange section of the cylindrical enclosure, and is welded to said flat flange section (2f).

### TECHNICAL FIELD

The present disclosure generally pertains to cylindrical secondary cells and more precisely to a cylindrical secondary cell having an enclosure with an open end to which a lid is attached.

### BACKGROUND

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

A rechargeable battery, often referred to as a secondary battery, typically comprises one or more secondary cells electrically connected to each other.

### SUMMARY

It is in view of the above considerations and others that the embodiments of the present invention have been made. The present disclosure aims at providing highly reliable secondary cells that are efficient in manufacture. The number of components is to be reduced and the assembly thereof is to be simplified.

According to a first aspect of the present disclosure, a cylindrical secondary cell is provided. The cylindrical secondary cell comprises:
a cylindrical enclosure comprising a first enclosure end, a second enclosure end and an enclosure sidewall extending between the enclosure ends, wherein at least one enclosure end is open,
an electrode roll,
a lid, and
a current collector disc arranged between the lid and the electrode roll and in direct electrical contact with the electrode roll,
   wherein:
the cylindrical enclosure comprises a flat flange section extending from the enclosure sidewall at the open enclosure end, and
the radially outermost portion of the lid is configured to abut and match the flat flange section of the cylindrical enclosure, and is welded to said flat flange section.

According to this aspect, the enclosure sidewall does not comprise a beading groove. That is, the enclosure sidewall defines a cylinder having a constant radius along the entirety of its axial length. Put another way, the enclosure sidewall defines a constant cross-sectional profile between the enclosure ends.

The flat flange section may extend radially inwards or outwards from the enclosure sidewall. The flat flange section may extend from the enclosure sidewall at an angle, preferably between 75-105 degrees, such as 90 degrees.

Furthermore, in an example, the flat flange section has a thickness equal to the thickness of the enclosure sidewall. That is, the flat flange section may be formed by folding, crimping, or otherwise shaping an outer brim of the cylindrical sidewall.

In an example embodiment, the lid comprises at least one recessed contact portion that is configured to form the direct electrical contact with the current collector disc. The recessed contact portion may be between 50% and 80% of the surface area of the lid. Such recesses may also advantageously provide improve gripping locations for the lid, thereby improving the ease of manufacture of the cell.

Manufacturing the cylindrical secondary cell substantially as described above comprises welding the radially outermost portion of the lid to the flat flange section of the cylindrical enclosure, forming a welded portion. According to an optional refinement, the method further comprises folding or machining the welded portion to thereby reduce the radial profile of the welded portion.

Advantages associated with the present disclosure, and additional conceivable features, will become clear from the following description of embodiments and examples.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings, in which

FIG. 1 schematically illustrates a cylindrical secondary cell in cross-section,

FIG. 2 schematically shows a cylindrical secondary cell wherein the cylindrical enclosure comprises a flat flange section extending from the enclosure sidewall, according to an embodiment of the present disclosure,

FIG. 3 schematically shows an alternative embodiment to the one of FIG. 2,

FIG. 4 schematically shows another alternative embodiment to the one of FIG. 2,

FIG. 5 schematically shows another alternative embodiment to the one of FIG. 2, and

FIGS. 6a-b schematically show another alternative embodiment to the one of FIG. 2, before and after a folding of the welded flange.

### DETAILED DESCRIPTION

Embodiments of the present disclosure will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art.

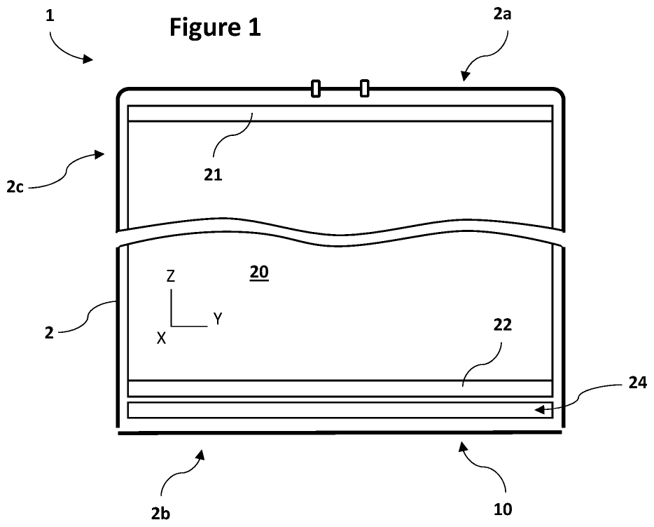

FIG. 1 shows a cylindrical secondary cell 1 (hereinafter referred to as cell) in a cross-sectional side view. In the exemplified embodiment, the cell 1 is circular cylindrical. The cell 1 comprises a cylindrical enclosure 2 having a first enclosure end 2a, an opposite second enclosure end 2b and an enclosure sidewall 2c that extends between the enclosure ends 2a, 2b. In the exemplified embodiment, the first and second enclosure ends 2a, 2b are circular. The enclosure sidewall 2c is circular cylindrical. The cell 1, and thus its enclosure sidewall 2c, may be elongate and extend along a longitudinal axis (Z-axis in FIG. 1). The enclosure ends 2a, 2b may extend in planes (XY-planes in FIG. 1) that are perpendicular to the longitudinal axis. As is illustrated, the first enclosure end 2a, or first enclosure end side (top side in FIG. 1), may be formed in one piece with the enclosure sidewall 2c.

The second enclosure end 2b is open and a separate lid 10, as shown, is attached to the cylindrical enclosure 2 at the open enclosure end 2b. Thus, the lid 10 forms the second enclosure end side (bottom side in FIG. 1). Alternatively, both ends sides may be formed by respective lids. In typical embodiments, as is illustrated in FIG. 1, the main portion of the enclosure sidewall 2c is essentially straight. The main portion of the enclosure sidewall 2c extends in parallel with the longitudinal axis (Z-axis in FIG. 1) of the cell 1. For example, the main portion of the enclosure sidewall 2c may be defined as at least 80 percent of the enclosure sidewall 2 c extension along the longitudinal axis.

As is illustrated in FIG. 1, the cell 1 further comprises an electrode roll 20. The electrode roll 20 comprises a first and a second conductive sheet 21, 22 and separating means (not shown). The separating means may also be termed separator. The conductive sheets 21, 22 and the separating means are rolled to form a circular cylindrical roll. The conductive sheets 21, 22 are coated with electrode coatings and on assembly of the cell 1, the cylindrical enclosure 2 is filled with an electrolyte. The coatings on the conductive sheets 21, 22 act as cathode and anode, respectively. The cathode, anode and electrolyte provide electrochemical energy storage. This principle is known per se, and the electrode roll 20 is commonly referred to as a jelly roll.

As shown in FIG. 1, the conductive sheets 21, 22 of the electrode roll 20 are axially offset in relation to one another, and each conductive sheet may comprise an end section that is not coated with electrode coating. Via the non-coated end sections, the respective ends of the electrode roll may be efficiently electrically connected to a respective assigned terminal of the cell 1. This design is known per se and commonly referred to as a tabless cell.

As is illustrated in FIG. 1, one 21 of the conductive sheets is in electrical contact, more precisely in direct electrical contact, with the closed end 2a of the cylindrical enclosure, while the other 22 of the conductive sheets is in direct electrical contact with a current collector disc 24, which in turn is in electrical contact with the lid 10 (although these components are schematically shown as not touching).

Direct electrical contact may be referred to as physical contact. Typically, the current collector disc 24 is welded, e.g. laser welded, to the conductive sheet 22, but in some embodiments, the current collector disc 24 is held or pressed against the conductive sheet 24 without welding.

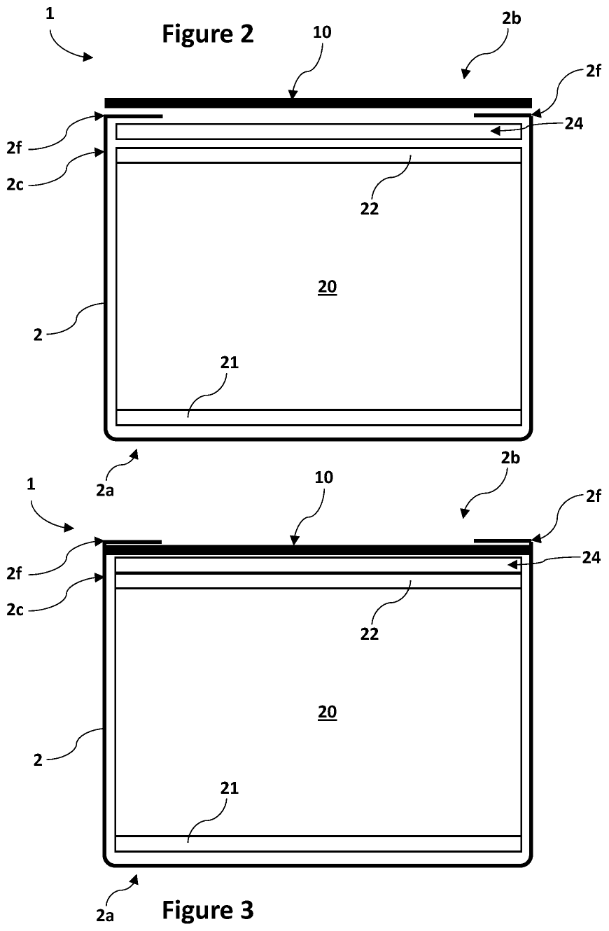

As shown in FIGS. 2 to 6b, the cylindrical enclosure 2 comprises a flat flange section 2f extending from the enclosure sidewall 2c at the open enclosure end 2b, and the radially outermost portion of the lid 10 is configured to abut and match the flat flange section 2f of the cylindrical enclosure 2. The lid 10 is welded to said flat flange section 2f, for example using laser welding, ultrasonic welding, or the like. The flat flange section 2f may be formed by folding, crimping, bending, or similarly shaping the enclosure sidewall 2c at the open enclosure end 2b.

As shown in the embodiment of FIG. 2, the flat flange section 2f is formed at a location on the enclosure sidewall 2c above the current collector disc 24. In addition to being welded to the lid 10, the flat flange section 2f may be welded to the current collector disc 24. The flat flange section 2f provides an advantageously larger surface area for welding the lid 10 to the cylindrical enclosure, thus enabling a better seal of the cell 1 by the lid 10. In an optional refinement, the flat flange section 2f may be angled downwards into the interior of the cell 1 so as to push against the current collector disc 24 and hold it in place.

As shown in the embodiment of FIG. 3, the flat flange section 2f is formed at a location on the enclosure sidewall 2c above the current collector disc 24 and the lid 10. As with the embodiment of FIG. 2, the flat flange section 2f may be angled downwards into the interior of the cell 1 so as to push against the lid 10 and the current collector disc 24 and hold them in place.

Such an embodiment may be manufactured by arranging the electrode roll 20 in the cylindrical enclosure 2, arranging the current collector disc 24 in direct electrical contact with the exposed uncoated conductive sheet 22, arranging the lid 10 in contact with the current collector disc 24, and then forming the flat flange section 2f over the lid 10. The flat flange section 2f may be welded to the lid 10 at an edge of the flat flange section 2f so as to provide a welded joint that is easily inspectable and able to be electrically tested in-line in a manufacturing process for the cell 1.

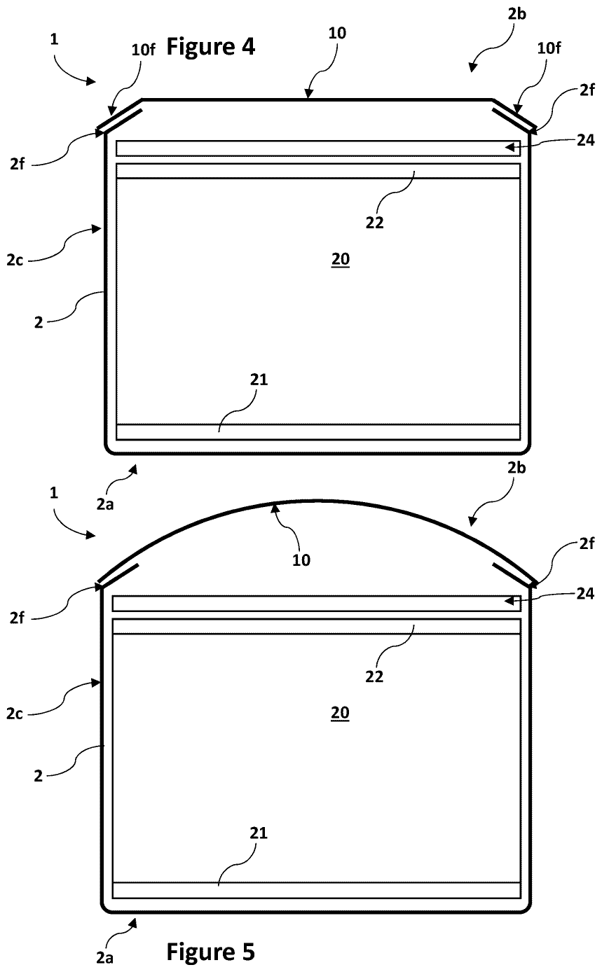

The lid 10 shown in FIGS. 2 and 3 may be generally disc-shaped. The lid 10 may have the general shape of a circular plate. In some examples, such as that shown in FIG. 4 the lid 10 may comprise a circular disc that at the radially outer end comprises a flange 10f. The flange 10f may extend from the circular disc in a direction away from or towards the cylindrical enclosure 2, or parallel or tangential to the disc when the lid 10 is attached to the cylindrical enclosure 2. The circular disc and the flange 10f are preferably formed in one integral piece. By angling the flat flange section 2f of the cylindrical enclosure 2 and the flange 10f of the lid, the lid 10 may be more easily centered on the cylindrical enclosure 2 during a manufacturing process of the cell 1.

In the example shown in FIG. 4, the current collector disc 24 may be welded to the sidewall 2c of the cylindrical enclosure 2. In an optional refinement, the current collector disc 24 may comprise a flange to increase the contact area between the current collector disc 24 and the cylindrical enclosure 2.

Furthermore, the lid 10 may comprise a groove or notch for providing an opening in the lid 10 if a pressure to which the lid 10 is subjected, i.e. a pressure inside the cylindrical enclosure 2, reaches a threshold value. In such a situation, gas and/or other ejecta may be released out of the cell 1 through the opening formed in the lid 10. The opening formed in the lid 10 as a result of the notch breaking may be referred to as a vent opening.

In the embodiment shown in FIG. 5, the lid 10 may be curved so as to adopt a partially spherical or ‘bowl’ shape. In the illustrated example, the lid 10 is convex as viewed from an external of the cell 1, but in other examples, the lid 10 may be concave. The lid 10 is shaped so as to substantially abut the flat flange section 2f of the cylindrical enclosure 2. Such a shape of the lid 10 may advantageously improve the resilience of the lid 10 against an increased internal pressure of the cell 1.

As is illustrated in FIGS. 2 to 5, the cell 1 may be configured such that the lid 10 does not protrude radially beyond the cylindrical enclosure 2. This may be beneficial as a great number of cells 1 are typically arranged next to one another or in a holder structure in a secondary battery. In this connection, a protruding lid may impede an assembly process or a tight arrangement of cells.

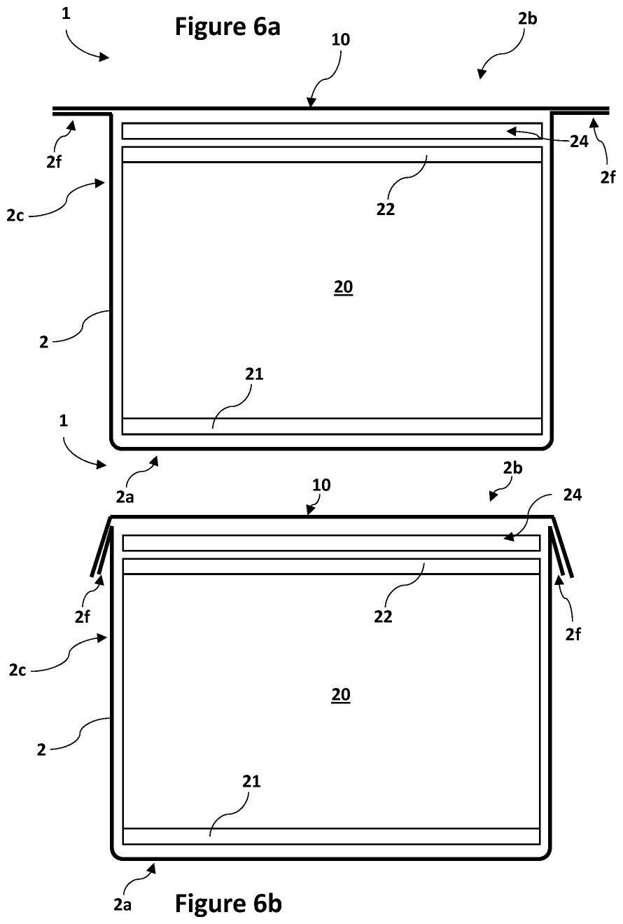

In the embodiment shown in FIGS. 6a and 6b, the flat flange section 2f may extend radially outwards from the enclosure sidewall 2c and the lid 10 may be sized so as to match the outer dimensions of the flat flange section 2f, i.e., such that the lid 10 and flat flange section 2f are flush when arranged in abutment.

The lid 10 may be welded to the flat flange section 2f and then the welded connected part may be sized down (e.g., radially) so as to reduce the overall dimensions of the cell 1. The sizing down may comprise folding the welded flat flange section 2f and lid 10, as shown in FIG. 6b. Alternatively, the sizing down may comprise grinding, cutting, or otherwise machining the flat flange section 2f and the lid 10 in a way that substantially preserves the welded connection therebetween.

FIG. 1 illustrates a cell 1 of a type that has both a positive terminal and a negative terminal at one and the same end 2a (the top end in FIG. 1) of the cylindrical secondary cell 1. The first enclosure end 2a comprises a central terminal through-hole for the positive terminal. The negative terminal is electrically connected to the cylindrical enclosure 2. More precisely, the negative terminal is formed by the top surface of the cylindrical enclosure 2 that surrounds the terminal through-hole. Thus, the entire cylindrical enclosure 2 (apart from the positive terminal at the top end) may be the negative terminal.

A cell 1 having both terminals at one end may bring advantages as regards electrically connecting the cell to a load. Conductors electrically connecting the terminals to the load may be positioned on the same end, the terminal end (top side in FIG. 1), of the cell. The opposite end, which may be referred to as the electrolyte-filling end (bottom end in FIG. 1), of the cell 1 may be dedicated to electrolyte filling and venting. An overpressure may be generated within the cell during operation, in particular upon malfunction of the cell or of the load connected to the cell. Such malfunction may require a release of gas and/or other ejecta out of the cell, and it may be advantageous to direct the released gas and/or other ejecta away from the conductors, i.e. at the end opposite to the terminal end.

A number of cells 1 may be positioned at a low position in an electric vehicle. The cells 1 may be arranged with the terminal ends directed upwards and the electrolyte-filling ends (bottom end 2b in FIG. 1) directed downwards. Upon malfunction, for example resulting from a faulty electric vehicle charger or a faulty cell 1, a release of gas and/or other ejecta from the electrolyte-filling end(s) will be advantageously directed downwards towards the ground beneath the vehicle. In other applications than vehicles, the electrolyte-filling ends may be directed towards a desired location such that any gas and/or other ejecta will not cause damages or injuries.

In the figures, the material thickness of the cell 1 and the lid 10 have been exaggerated to elucidate the features of the present disclosure. For the same reason, the figures illustrate a certain gap between the cylindrical enclosure 2, the current collector disc 24, and the lid 10. It will be understood that in actual implementations the lid 10 will be brought in direct contact with the cylindrical enclosure 2 (in particular the flange 2f) before attachment, i.e., by welding. In some examples, the flat flange section 2f has a thickness equal to the thickness of the enclosure sidewall 2c.

Modifications and other variants of the described embodiments will come to mind to ones skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure.

Furthermore, although specific terms may be employed herein, they are used in a generic and descriptive sense only and not for purposes of limitation. Therefore, persons skilled in the art would recognize numerous variations to the described embodiments that would still fall within the scope of the appended claims. As used herein, the terms “comprise/comprises” or “include/includes” do not exclude the presence of other elements or steps.

Furthermore, although individual features may be included in different claims (or embodiments), these may possibly advantageously be combined, and the inclusion of different claims (or embodiments) does not imply that a certain combination of features is not feasible and/or advantageous. In addition, singular references do not exclude a plurality. Finally, reference numerals in the claims are provided merely as a clarifying example and should not be construed as limiting the scope of the claims in any way.

1. A cylindrical secondary cell (1), comprising:
a cylindrical enclosure (2) comprising a first enclosure end (2a), a second enclosure end (2b) and an enclosure sidewall (2c) extending between the enclosure ends (2a, 2b), wherein at least one enclosure end (2b) is open,
an electrode roll (20),
a lid (10), and
a current collector disc arranged between the lid and the electrode roll (20) and in direct electrical contact with the electrode roll (2),
wherein:
the cylindrical enclosure (2) comprises a flat flange section extending from the enclosure sidewall (2c) at the open enclosure end (2b), and
the radially outermost portion of the lid (10) is configured to abut and match the flat flange section of the cylindrical enclosure, and is welded to said flat flange section.

2. The cylindrical secondary cell (1) of claim 1, wherein the flange section extends radially inwards or outwards from the enclosure sidewall (2c).

3. The cylindrical secondary cell (1) of claim 1, wherein the flat flange section has a thickness equal to the thickness of the enclosure sidewall (2c).

4. The cylindrical secondary cell of claim 1, wherein the flat flange section extends radially inwards or outwards from the enclosure sidewall (2c) at an angle.

5. The cylindrical secondary cell of claim 1, wherein the lid (10) comprises at least one recessed contact portion (11) that is configured to form the direct electrical contact with the current collector disc.

6. A method for manufacturing the cylindrical secondary cell according to claim 1, the method comprising:
welding the radially outermost portion of the lid (10) to the flat flange section of the cylindrical enclosure, forming a welded portion.

7. The method of claim 6, further comprising folding or machining the welded portion to thereby reduce the radial profile of the welded portion.

8. The cylindrical secondary cell of claim 4, wherein the angle is between 75 and 105 degrees.

9. The cylindrical secondary cell (1) of claim 2, wherein the flat flange section has a thickness equal to the thickness of the enclosure sidewall (2c).

10. The cylindrical secondary cell of claim 9, wherein the flat flange section extends radially inwards or outwards from the enclosure sidewall (2c) at an angle.

11. The cylindrical secondary cell of claim 10, wherein the angle is between 75 and 105 degrees.

12. The cylindrical secondary cell (1) of claim 9, wherein the lid (10) comprises at least one recessed contact portion (11) that is configured to form the direct electrical contact with the current collector disc.
